(19) United States
(12) Patent Application Publication
(10) Pub. No.: US 2012/0029844 A1
(43) Pub. Date: Feb. 2, 2012

(54) DETERMINING ELASTIC MODULUS FOR CONTINUOUS MATERIAL WEB

(75) Inventors: Markku HAIKOLA, Nummela (FI); Vesa Kajander, Klaukkala (FI)

(73) Assignee: ABB Oy, Helsinki (FI)

(21) Appl. No.: 13/229,472

(22) Filed: Sep. 9, 2011

Related U.S. Application Data
(63) Continuation of application No. PCT/FI2010/050175, filed on Mar. 9, 2010.

(30) Foreign Application Priority Data
Mar. 10, 2009 (FI) 20095236
Mar. 18, 2009 (FI) 20095282

(51) Int. Cl. G01L 5/04; G06F 19/00

(52) U.S. Cl. 702/43

(57) ABSTRACT

A method and apparatus are disclosed for determining elastic modulus for a continuous material web, in which method a continuous material web runs on a roll driven by an electric motor drive. The method includes determining material web speed v₂, providing a change in an adjustable characteristic of the continuous material web by the electric motor drive, the characteristic being material web tension T, torque M acting on the material web or material web speed v₂, calculating elastic modulus E on the basis of the determined material web speed v₂ and speed change Δv₂ and torque change ΔM or material web tension change ΔT.

### RELATED APPLICATIONS

This application claims priority as a continuation application under 35 U.S.C. §120 to PCT/F12010/050175, which was filed as an International Application on Mar. 9, 2010 designating the U.S., and which claims priority to Finnish Patent Application No. 20095236 filed in Finland on Mar. 10, 2009 and Finnish Patent Application No. 20095282 filed in Finland on Mar. 18, 2009. The entire contents of these applications are hereby incorporated by reference in their entireties.

### FIELD

The disclosure relates to determining an elastic modulus for a continuous material web, for example, a paper web, and to determining an elastic modulus from a continuous material web while the web is moving in a production machine.

### BACKGROUND INFORMATION

A property that can be determined, for example, for paper and paperboard is elastic modulus. Elastic modulus relates to reversibility response of a material subjected to tension. The elastic modulus is determinable as a ratio of tension to an elongation caused by extension, the extension taking place on a linear area and reversing once a pulling tension is released.

An elastic modulus of, for example, paper and paperboard, can have an influence on both a runability of a production machine and quality of an end product. Often the end product is given a specific value or a threshold value, which the elastic modulus is to meet. A low elastic modulus in packing materials, for example, can mean that the material may tear too easily during packing. Similarly, with regard to paper used for printed matter, runability in printing machines can depend in part on elastic modulus.

Elastic modulus can be determined with laboratory measurements of finished material. For example, when a paper machine has produced a completed machine roll, a sample is taken from the paper to a laboratory for measurement. A result of the measurement can be obtained, at best, after hours from the completion of the machine roll. If the elastic modulus deviates significantly from the threshold value, an entire machine roll of paper can be wasted. Moreover, because of long delays, a quick adjustment of the production process on the basis of laboratory measurements can be difficult.

Known methods for on-line measurement of elastic modulus include those in which the measurement sensors do not come into contact with the material web. One of these is a method based on a measurement of changes in web width. The web width measurement and a mathematic model together allow a tensile strength ratio to be estimated and thus to draw conclusions on the characteristics of the paper during production.

Another known method is to send high-frequency acoustic bursts to a surface of the paper and observe a correlation between frequency modulation and the elastic modulus of the paper.

The tensile strength of paper may also be estimated on the basis of fibre orientation.

All the above methods for determining the elastic modulus or tensile strength of paper involve measurement devices specifically devised for this purpose. Other aspects that can influence the reliability of the results of acoustic measurements are a challenging environment and high web speed. Moreover, an acoustic measurement is taken on a point of the material web and therefore does not necessarily illustrate the properties of the entire material. Mathematical models based on the measurement of web width, in turn, involve a comprehensive research material for a reliable model to be obtained.

U.S. Pat. No. 6,993,964 discloses a method, in which web speed and tightness are measured at two different web spans, elastic modulus being determined on the basis of these measurement data.

### SUMMARY

A method is disclosed for determining an elastic modulus for a continuous material web running on a roll controlled by an electric motor drive, the method comprising: determining a material web speed v₂ using a frequency converter of the electric motor drive; providing a change to a controllable property of the continuous material web with the electric motor drive, the controllable property being material web tension T, torque M acting on the material web and/or material web speed v₂; determining a material web speed change, caused by a change provided with the electric motor drive to the controllable property, with the frequency converter; determining a torque change ΔM and/or a change in material web tension ΔT, caused by the change provided with the electric motor drive to the controllable property, with the frequency converter; and calculating elastic modulus E based on the determined material web speed v₂ and speed change Δvₑ together with the torque change ΔM or change in material web tension ΔT.

An apparatus is disclosed for determining an elastic modulus for a continuous material web running on a roll, comprising: an electric motor drive for driving a roll of an electric motor drive; a frequency converter arranged for determining speed of a material web, the electric motor drive providing a change to a controlled property of a continuous material web, the controllable property being material web tension, torque acting on the material web and/or material web speed, and the frequency converter of the electric motor drive being configured for determining a material web speed change caused by a change provided with the electric motor drive to the controllable property, and determining a torque change or a change in material web tension caused by the change provided with the drive to the controllable property; means for calculating an elastic modulus based on a determined material web speed and a change in speed together with a change in torque or a change in material web tension.

A tangible computer program product is disclosed comprising a computer program code for determining elastic modulus for a continuous material web running on a roll controlled by an electric motor drive, the computer program code, when run on a computer, causing the computer to: determine material web speed v₂ using a frequency converter of the electric motor drive; provide, with the electric motor drive, a change to a controllable property of the continuous material web, the controllable property being material web tension T, torque M acting on the material web or material web speed v₂; determine, with the frequency converter a material web speed change Δv₂ caused by the change provided with the electric motor drive to the controllable property; determine, with the frequency converter, a torque change or a change in material web tension caused by the change provided with the electric motor drive to the controllable property; and calculate elastic modulus E based on the determined material web speed v₂ and speed change Δv₂ together with the torque change ΔM or change in material web tension ΔT.

### BRIEF DESCRIPTION OF THE DRAWINGS

In the following, exemplary embodiments will be described in greater detail with reference to the accompanying drawings, in which:

FIG. 1 is a schematic view of a material web controlled by an electric motor drive according to an exemplary embodiment of the disclosure; and

FIG. 2 is an example of a tension-elongation curve.

### DETAILED DESCRIPTION

An exemplary embodiment of the disclosure relates to determining elastic modulus for a material and quantities to be derived therefrom by using information obtained from an electric motor drive running the material web. A controlled electric motor drive coupled to a roll produces data on a speed of the web running on the roll and on a torque acting on the web, the elastic modulus being calculated on the basis of these.

Exemplary methods and arrangements of the disclosure can provide a simple way for implementing a measuring arrangement. Elastic modulus may be measured without any measuring devices on the material web. Hence neither installation of measurement devices nor maintenance service thereof is needed. In addition, when, for example, sensors installed for the purpose become broken, elastic modulus can become difficult to determine.

Elastic modulus measured on line may be utilized in various ways during the production process, post-processing as well as in the end product.

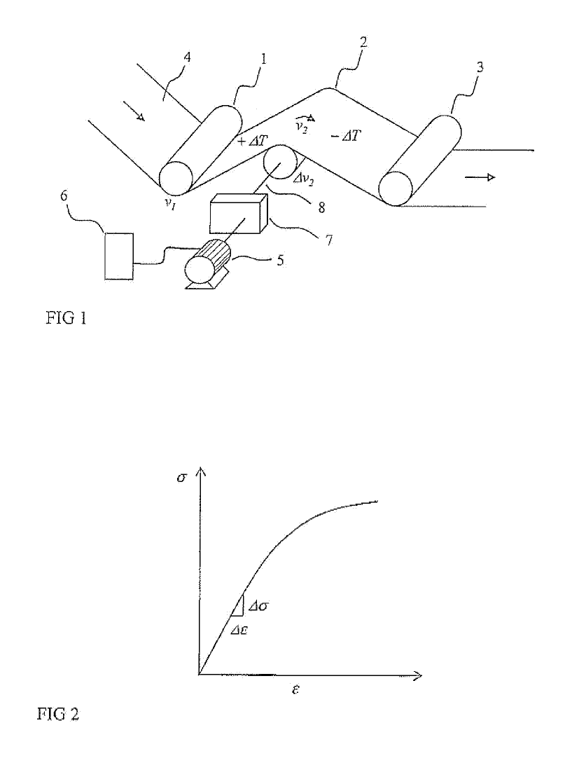

FIG. 1 is a schematic view of a continuous material web in a manufacturing machine for the material in question. An example of this is a paper web in a paper machine. FIG. 1 shows how the paper web 4 travels on three rolls 1, 2, 3. The figure illustrates, for example, how roll 2 is controlled by electric motor drives including an electric motor 5 and a frequency converter or a similar device 6 feeding the motor. The shaft of the motor 5 is coupled via a gearbox 7 to a roll axis for rotating the roll in a desired manner. It is to be noted that a gearbox is not necessary, which allows the motor shaft to be coupled directly to the roll. The motor can be an electric motor of any type, such as an induction motor or a synchronous motor.

Motors rotating the rolls can be controlled in various ways by modern frequency converters or similar controllers. The control can be carried out as a speed control, for example, while maintaining the web under a desired tension. The control can be carried out in a situation where one of the motors produces a desired web speed and motors connected to this via the paper web are controlled by torque control to achieve and maintain a desired tension. There is a linear correlation between the torque and the web tension, because the force acting on the web width is web tension, the torque in turn being the product of the roll radius and the web force.

In a situation where the material web travels between two holding rolls in a static state, a relative elongation between rolls 1 and 2 of FIG. 1 may be determined by the following equation:

$$ɛ = \frac{{v}_{2} - {v}_{1}}{v 1} . \qquad ( 1 )$$

In a static state, change Δvₑ in speed v₂ causes a change in elongation:

$$Δɛ = \frac{Δ {v}_{2}}{{v}_{2}} , \qquad ( 2 )$$

when v₁ is a constant and essentially equal to v₂.

Because the ratio of tension to elongation is substantially linear on small elongations and small changes in elongation, Hooke's law can be applied:

σ=Eε, (3)

which defines tension a as the product of elastic modulus E and elongation ε. Tension may be determined as a ratio of web force to a web surface area perpendicular to the force:

$$σ = \frac{F}{A} . \qquad ( 4 )$$

Equation (4) may further lead to:

$$σ = \frac{F}{lh} = \frac{T}{h} , \qquad ( 5 )$$

because surface area A is the product of paper web height h, i.e., thickness, and width l and web tension T is the ratio of web force F to web width l.

The following notation may be obtained from equations (3) and (5):

$$E ɛ = \frac{T}{h} \qquad ( 6 )$$

and further:

$$E Δɛ = \frac{Δ T}{h} . \qquad ( 7 )$$

Equation (7) is valid, because the ratio of changes in tension to those in elongation is linear when the changes are small.

By inserting equation (2) to equation (7) we obtain:

$$E \frac{Δ {v}_{2}}{{v}_{2}} = \frac{Δ T}{h} . \qquad ( 8 )$$

With roll radius r and possible gearbox transmission ratio i taken into account, change ΔM in torque M of the motor may be expressed as follows:

$$Δ {M}_{2} = \frac{Δ Fr}{i} = \frac{2 Δ Tlr}{i} , \qquad ( 9 )$$

from which the change in tension may then be calculated as follows:

$$Δ T = \frac{Δ {M}_{2} i}{2 lr} \qquad ( 10 )$$

Further, elastic modulus E is solved from equation (8) and equation (10) is inserted into this solution:

$$E = \frac{Δ {Tv}_{2}}{h Δ {v}_{2}} = \frac{Δ {M}_{2} {iv}_{2}}{h Δ {v}_{2} 2 lr} , \qquad ( 11 )$$

from which we see that the value of the elastic modulus may be determined using the torque change, web speed and web speed change, and known parameters. The torque change, web speed and web speed change can be obtained directly from the frequency converter, which controls the motor coupled to the roll. Similarly, gearbox transmission ratio i and roll radius r in equation (11) may be stored in the memory, for example, of the frequency converter. Paper web thickness h and width/may vary, and these values can be stored either on the basis of measurements made during use or as known parameters.

In accordance with the disclosure, material web speed v₂ is determined and a change into an adjustable property of the material web is introduced by the electric motor drive. These adjustable properties include material web tension, torque acting on the material web and material web speed.

Further in accordance with the disclosure, the elastic modulus can be calculated on the basis of the determined material web speed and the speed change as well as on the basis of the torque change or a change in the material web tension. In the above equations the material web speed was changed. This kind of change can be implemented directly by instructing the motor to change the web speed. This change in the web speed influences the torque on the roll, as expressed in the equations. It is to be noted that the acting torque can be considered to be either a torque acting on the material web or a torque caused by the material web on the roll. Although interpreted differently, these torques are, however, equal in magnitude.

As stated above, an induced change in speed caused a change in torque. These changes and the parameters involved in the web speed and drive allow the magnitude of the elastic modulus to be calculated.

Similarly, the torque or tension subjected to the material web by the roll can also be changed. This change in turn can cause a change to the corresponding roll. Equation (11) shows the elastic modulus as a function of both a tension change ΔT and a torque change ΔM. A tension change is useful, for example, when the tension of a tension-adjusted material web is changed in order to calculate elastic modulus. In that case the original web speed, change in the web speed caused by a change in tension and a change in tension can be applied to equation (11) to calculate an elastic modulus value by also taking into account the thickness of the material web.

The term “speed” as used above refers to the speed of the material web. This speed correlates in a known linear manner with the angular speed of the motor, which means that if desired, motor angular speeds may be applied instead of web speeds. Known frequency converters are able to internally determine the magnitude of the torque produced by the motor or that of the torque subjected to the motor as well as the web or angular speed. As stated above, the determining of web tension is based on the determining of torque, and therefore all quantities to be determined in the method of the disclosure can be directly known by the control unit of the frequency converter. These quantities can be conveyed as such to a separate computation unit, such as a microprocessor coupled to a memory, and from there to a higher level control system, such as an automation system controlling the drives. The frequency converter itself can also be arranged to carry out the necessary calculations for determining elastic modulus. In these cases, the frequency converter can transmit calculated elastic modulus value to the higher level.

In the above, the equipment driving the roll has been specifically referred to as a combination of a frequency converter and an induction motor or a synchronous motor. A corresponding functionality for implementing the method of the disclosure can also be provided by a direct-current motor and equipment driving the motor.

Determining an elastic modulus in accordance with exemplary embodiments of the disclosure can be carried out at specific timed intervals when the material web is in a static state. The elastic modulus can also be determined on a continuous basis by providing the roll performing the determining with a slight variation in speed instruction, for example. For accuracy of the elastic modulus determination, it is desirable that the roll at which the elastic modulus is determined is a holding roll. This means that the surface speed and the web speed of the roll should correspond to one another as precisely as possible to prevent the material web from sliding on the roll.

An exemplary method of the disclosure can allow the point of operation of the material web to be evaluated on the basis of elastic modulus. Elastic modulus is an angular coefficient of a tension-elongation curve that may be formed for the material, as shown in FIG. 2. Within a range of low elongation values, the angular coefficient of the material is relatively high. As the angular coefficient becomes smaller, an identical change in the tension of the material web, i.e., the web force, increases elongation. When the web force is further increased, a breaking point of the material web is achieved, i.e., the break resistance of the material has been exceeded. Before this point the angular coefficient of the curve, i.e., its elastic modulus, is small. Thus, the method of the disclosure allows to deduce situations where the tension of the material web threatens to break the web. This information can be directly applied to the adjustment of the web by lowering the tension instruction, or the like, when the angular coefficient is significantly small.

Situations of manufacturing paper or a similar material take place in a linear tension-elongation curve area, where the magnitude of the elastic modulus to be calculated by the method does not vary essentially. When decrease in the elastic modulus is observed, the tension of the material has changed essentially while quality has remained the same. This can allow improvement in the runability and diagnostics of, for example, a machine for manufacturing paper.

Further, elastic modulus determined according to an exemplary method of the disclosure during the material production can provide added value when reasons for web breaks are to be diagnosed. Unexpected variations in elastic modulus of the material can cause problems in material runability when standard quality material would be driven on the linear tension-elongation curve area. Recording the elastic modulus values determined according to the disclosure enables to detect correlations even to process disturbances at the upstream end of the production machine. In particular, if the elastic modulus shows cyclically varying changes, it can be possible to locate problems in the operation of the production machine on the basis of the cycle.

Elastic modulus values determined by an exemplary method of the disclosure, or deviations from elastic modulus values considered as normal, can be indicated on a completed machine roll either by a marking on the edge of the finished material or by using, for example, an electric recording means. These markings allow material defined as reject to be removed from devices where the material is to be processed further.

Exemplary equipment as disclosed herein includes an apparatus for determining the speed of the material web, an electric motor drive of the equipment being arranged to provide a change in an adjustable property of the continuous material web, the property being material web tension, torque acting on the material web or material web speed. The equipment can further be arranged to calculate elastic modulus on the basis of the determined material web speed and a change in speed and a change in torque or a change in the material web tension. These can be implemented by an electric motor drive, the electric motor drive having computing capacity for carrying out the necessary computations and readable memory for taking into account the specified parameters in the computations. The computing capacity can also reside in a control system including, for example, a microprocessor coupled to a memory, which may receive measurement data from the process and data produced by the frequency converter.

The disclosure can be implemented into existing systems or by using separate elements and devices in a centralized or distributed manner. Existing devices, such as electric motor drives can, for example, include a processor and a memory that may be utilized to implement the functionality of the embodiments of the disclosure. Hence all changes and configurations needed for implementing the embodiments of the disclosure, can be performed by software routines, which in turn may be implemented as added or updated software routines. If the functionality of the disclosure is implemented by software, the software may be provided as a computer program product including a readable computer program code which, when run on a computer, causes the computer, or similar equipment, to perform the functionality of the disclosure as described above. The computer program code may be stored on a tangible computer readable medium, such as a suitable memory, for example, a flash memory or on a disc memory, from which it is readable to the unit or units executing the program code. In addition, the program code may be loaded to the unit or units executing the program code through a suitable data network and it may replace or update a possibly existing program code.

A person skilled in the art will find it apparent that as technology advances, basic ideas of the disclosure may be implemented in various ways. The disclosure and its embodiments are therefore not restricted to the above examples but may vary within the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for determining an elastic modulus for a continuous material web, running on a roll controlled by an electric motor drive, the method comprising:
determining a material web speed v₂ using a frequency converter of the electric motor drive;
providing a change to a controllable property of the continuous material web with the electric motor drive, the controllable property being material web tension T, torque M acting on the material web and/or material web speed v₂;
determining a material web speed change Δv₂, caused by a change provided with the electric motor drive to the controllable property, with the frequency converter;
determining a torque change ΔM and/or a change in material web tension ΔT, caused by the change provided with the electric motor drive to the controllable property, with the frequency converter; and
calculating elastic modulus E based on the determined material web speed v₂ and speed change Δv₂ together with the torque change ΔM or change in material web tension ΔT.

2. The method according to claim 1, comprising:
providing a change in material web speed v₂ using the electric motor drive;
determining the torque acting on the material web before and after the change in speed to provide torque change ΔM; and
calculating elastic modulus E based on material web speed v₂, and the material web speed change Δv₂ and torque change ΔM caused by the material web speed change.

3. The method according to claim 1, comprising:
providing a change in material web tension T using the electric motor drive;
determining material web speed change Δv₂ caused by material web tension change ΔT; and
calculating elastic modulus E based on material web speed v₂ and the change in material web tension ΔT and the motor speed change Δv₂ caused by the change in the material web tension.

4. The method according to claim 1, comprising:
providing a change in torque M acting on the material web using the electric motor drive;
determining material web speed change Δv₂ caused by torque change ΔM; and
calculating elastic modulus E based on material web speed v₂ and the material web torque change ΔM, and the motor speed change Δv₂ caused by the change in the material web torque.

5. The method according to claim 1, comprising:
determining the material web speed and the torque acting on the material web in the electric motor drive.

6. The method according to claim 1, comprising:
comparing elastic modulus values determined by different measurements; and
reducing the material web tension, when a decrease in elastic modulus is observed.

7. The method according to claim 1, comprising:
determining the elastic modulus in the electric motor drive.

8. The method according to claim 1, wherein the electric motor drive transmits data needed for determining the elastic modulus to a higher level, where the elastic modulus is determined.

9. The method according to claim 1, wherein the calculating of the elastic modulus includes:
considering web thickness, web width and radius of a roll to be driven, and gear transmission ratio between the electric motor drive and the roll.

10. The method according to claim 1, wherein the motor in the electric motor drive is an alternating current motor or a direct current motor.

11. The method according to claim 2, comprising:
determining the material web speed and the torque acting on the material web in the electric motor drive.

12. The method according to claim 3, comprising:
determining the material web speed and the torque acting on the material web in the electric motor drive.

13. The method according to claim 4, comprising:
determining the material web speed and the torque acting on the material web in the electric motor drive.

14. A method according to claim 2, comprising:
comparing the elastic modulus values determined by different measurements; and
reducing the material web tension, when a decrease in elastic modulus is observed.

15. A method according to claim 3, comprising:
comparing the elastic modulus values determined by different measurements; and
reducing the material web tension, when a decrease in elastic modulus is observed.

16. A method according to claim 2, comprising:
determining the elastic modulus in the electric motor drive.

17. An apparatus for determining an elastic modulus for a continuous material web running on a roll, comprising:
an electric motor drive for driving a roll of an electric motor drive;
a frequency converter arranged for determining speed of a material web, the electric motor drive providing a change to a controlled property of a continuous material web, the controllable property being material web tension, torque acting on the material web and/or material web speed, and the frequency converter of the electric motor drive being configured for determining a material web speed change caused by a change provided with the electric motor drive to the controllable property, and determining a torque change or a change in material web tension caused by the change provided with the drive to the controllable property;
means for calculating an elastic modulus based on a determined material web speed and a change in speed together with a change in torque or a change in material web tension.

18. The apparatus according to claim 17, wherein the motor in the electric motor drive is an alternating current motor or a direct current motor.

19. The apparatus according to claim 17, wherein the frequency converter is arranged as a part of the electric motor drive for controlling a roll on which a continuous web will run, the frequency converter being configured to be driven to provide a change in the controllable property and to calculate elastic modulus.

20. A tangible computer program product comprising a computer program code for determining elastic modulus for a continuous material web running on a roll controlled by an electric motor drive, the computer program code, when run on a computer, causing the computer to:
determine material web speed v₂ using a frequency converter of the electric motor drive;
provide, with the electric motor drive, a change to a controllable property of the continuous material web, the controllable property being material web tension T, torque M acting on the material web or material web speed v₂;
determine, with the frequency converter a material web speed change Δv₂ caused by the change provided with the electric motor drive to the controllable property;
determine, with the frequency converter, a torque change or a change in material web tension caused by the change provided with the electric motor drive to the controllable property; and
calculate elastic modulus E based on the determined material web speed v₂ and speed change Δv₂ together with the torque change ΔM or change in material web tension ΔT.
